(19) United States
(12) Patent Application Publication
(10) Pub. No.: US 2005/0110724 A1
(43) Pub. Date: May 26, 2005

(54) Driving circuit for an organic electroluminescence display

(76) Inventors: Chang Oon Kim, Yongin-Si (KR); Sung Tae Ahn, Kwacheon-Si (KR)

Correspondence Address: FENWICK & WEST LLP, SILICON VALLEY CENTER, 801 CALIFORNIA STREET, MOUNTAIN VIEW, CA, 94041, US

(21) Appl. No.: 10/992,911

(22) Filed: Nov. 18, 2004

(30) Foreign Application Priority Data
Nov. 21, 2003 (KR) 10-2003-0082853

(51) Int. Cl. G09G 3/30

(52) U.S. Cl. 345/76

(57) ABSTRACT

A driving circuit of an organic electroluminescence display is configured such that the driving current I(n) flowing through an n-th pixel of the organic electroluminescence display is determined not by the current flowing out of transistors of a transistor group B(n) that are geometrically most adjacent to the n-th pixel but by the current flowing out of transistors which are geometrically most adjacent to other pixels. This configuration reduces the variation in the differences between driving current flowing through adjacent pixels, thereby improving the display quality of the organic electroluminescence display.

### CROSS-REFERENCE TO RELATED APPLICATION

This application claims priority under 35 U.S.C. §119(a) from Republic of Korea Patent Application No. 10-2003-0082853 filed on Nov. 21, 2003.

### TECHNICAL FIELD

The present invention relates to a driving circuit of an organic electroluminescence (EL) display, and more specifically, to a driving circuit which can improve the display quality of an organic EL display by way of reducing variations in differences between current flowing through two adjacent pixels through a unique arrangement of pixels and the transistors providing the pixels with driving current.

### BACKGROUND OF THE INVENTION

An organic EL display, also known as an organic light-emitting diode (OLED) display, is a flat panel display which utilizes the self-luminescence phenomenon. Organic luminescent material emits light when electrons and holes therein are combined due to an electric field applied to the organic luminescent material. Since organic EL displays have the characteristics of low power consumption, high brightness, a high response rate, and yet are light-weighted, it is considered as the most promising next generation display applicable for a variety of electronic devices, such as mobile communication terminals, personal digital assistants, camcorders, palm PCs (personal computers), etc.

The organic EL display is categorized into polymer types and low-molecular types according to its own organic luminescent material and into passive matrix types and active matrix types according to its driving mechanisms.

FIG. 1 illustrates a conventional organic EL display including display components such as diodes and a driver IC driving the display components to display images. In FIG. 1, part 1 illustrates pixels along with diodes 19, 20, 21, 22 assigned to each pixel. Part 2 illustrates a driver IC comprising transistor groups providing each diode with driving current. The driver IC performs current control and screen saver and also provides driving current to the diodes through transistors. Explanations and drawings on functions of the driver IC irrelevant to the present invention are omitted herein. The organic EL display includes diodes each assigned to each pixel to display images. Current is provided to each diode by transistors connected to each of the diodes. That is, current for diode 19, diode 20, diode 21 and diode 22 is provided by transistor groups B(n−1), B(n), B(n+1) and B(n+2), respectively. For example, the amount of current I(n) driving the diode 20 is equal to the sum of current flowing out of two transistors 13, 14 forming the transistor group B(n). As with I(n), the current I(n+1) driving the diode 21 is equal to the sum of current flowing out of two transistors 15, 16 forming the transistor group B(n+1). As can be seen, the transistors in the driver of the conventional organic EL display are arranged in a simple manner in accordance with the order of the diodes of the organic EL display.

Referring to FIG. 1, transistors providing driving current to diodes are arranged in the order of B(n−1), B(n), B(n+1) and B(n+2). The transistor groups B(n−1), B(n), B(n+1) and B(n+2) are isolated from each other in the driver IC chip. I(n−1) refers to a driving current of the (n−1)-th pixel, I(n) refers to a driving current of the n-th pixel, and I(n+1) refers to a driving current of the (n+1)-th pixel of the organic EL display panel. As shown in FIG. 1, I(n−1) is equal to the sum of current flowing out of two transistors 11, 12 of a transistor group B(n−1), I(n) is equal to the sum of current flowing out of two transistors 13, 14 of a transistor group B(n), and I(n+1) is equal to the sum of current flowing out of two transistors 15, 16 of a transistor group B(n+1). The following relations hold for the current I(n−1), I(n), I(n+1):
I(n−1)=2×IB(n−1),
I(n)=2×IB(n),
I(n+1)=2×IB(n+1), [Equation 1]
where IB(n−1) represents a current flowing out of one of the two transistors (11, 12) of the transistor group B(n−1), IB(n) represents a current flowing out of one of the two transistors (13, 14) of the transistor group B(n), and IB(n+1) represents a current flowing out of one of the two transistors (15, 16) of the transistor group B(n+1).

ΔI herein denotes a difference between the pixel driving current flowing through two adjacent pixels. ΔI can be expressed by the following equations:
ΔI(n−1)=I(n−1)−I(n)=2[IB(n−1)−IB(n)],
ΔI(n)=I(n)−I(n+1)=2[IB(n)−IB(n+1)],
ΔI(n+1)=I(n+1)−I(n+2)=2[IB(n+1)−IB(n+2)], [Equation 2]

These equations show that ΔI(n), which is a difference between pixel driving current flowing through the n-th pixel and the (n+1)-th pixel, is equal to twice the value obtained by subtracting IB(n+1) (the current flowing out of one transistor of the transistor group B(n+1)) from IB(n) (the current flowing out of one transistor of the transistor group B(n)). In other words, since the difference between the pixel driving current flowing through the n-th pixel and the (n+1)-th pixel is determined by the current flowing out of the transistors of transistor groups B(n) and B(n+1), the difference between current flowing through pixels vary depending on current flowing out of transistor groups geometrically most adjacent to each pixel. Indeed, there have always been differences between current flowing out of different transistor groups. Specifically, there are differences in electrical characteristics (e.g. current output) according to physical locations in the driver IC chip, even though the transistors are manufactured under the same mask dimension and the same manufacturing process conditions. Such differences are expected to occur in a general semiconductor manufacturing process. The larger the distance between the transistors is, the greater the differences in electrical characteristics become. For example, the difference in electrical characteristics of transistors 13, 14 is small since the two transistors 13, 14 are located closely to each other (e.g. within several micrometers). On the other hand, the differences in electrical characteristics between transistor groups are large since the distance between the transistor groups is typically from tens to hundreds of micrometers.

As described above, the pixel driving current for a pixel in a conventional organic EL display depends on transistors belonging to a single transistor group, and so that the differences in electrical characteristics between pixels are large. This causes a problem of degrading brightness uniformity in the conventional organic EL display. The display quality of the organic EL display is good if the differences in current flowing through adjacent pixels get closer to zero. Therefore, there is a need for a driver for an organic EL display that can reduce the differences in current flowing through adjacent pixels, thereby improving display quality.

### SUMMARY OF THE INVENTION

The present invention provides a driving circuit for an organic EL display that has a unique arrangement of pixels and driving transistors in the driver IC to reduce variations in the driving current flowing through the adjacent pixels of the organic EL display. According to the present invention, I(n), a driving current of the n-th pixel, is determined not by the output current of the transistors belonging to the transistor group B(n) that is geometrically most adjacent to the n-th pixel, but by the output current of other transistor groups. IB(n) refers to current flowing out of one transistor of the transistor group B(n). In one embodiment and referring to FIG. 2 as an example, there are transistors 33, 34 forming the transistor group B(n), transistors 31, 32 forming the transistor group B(n−1), and transistors 35, 36 forming the transistor group B(n+1). According to the driving circuit for the organic EL display of the present invention, I(n) is equal to the sum of the current out of transistor 32 and transistor 35, I(n+1) is equal to the sum of the current out of transistor 34 and transistor 37, and I(n−1) is equal to the sum of the current out of transistor 30 and transistor 33. I(n), a driving current of the n-th pixel, is equal to the sum of IB(n−1) and IB(n+1), where IB(n−1) is current flowing out of one transistor of transistor group B(n−1) geometrically most adjacent to the (n−1)th pixel and IB(n+1) is current flowing out of one transistor of transistor group B(n+1) geometrically most adjacent to the (n+1)th pixel.

ΔI(n), the difference between the current I(n) flowing through the n-th pixel and the current I(n+1) flowing through the (n+1)-th pixel, is equal to the sum of one half of the value obtained by subtracting I(n) from I(n−1) and one half of the value obtained by subtracting I(n+2) from I(n+1).

The transistors may be complementary metal-oxide semiconductor (CMOS) transistors or bipolar junction transistors (BJTs).

### BRIEF DESCRIPTION OF DRAWINGS

The teachings of the present invention can be readily understood by considering the following detailed description in conjunction with the accompanying drawings. Like reference numerals are used for like elements in the accompanying drawings.

FIG. 1 is a simplified diagram of a driving circuit of a conventional organic electroluminescence (EL) display.

FIG. 2 is a simplified diagram of a driving circuit of an organic electroluminescence (EL) display according to one embodiment of the present invention.

FIG. 3a illustrates ΔI(n) which is obtained by a conventional driving circuit.

FIG. 3b illustrates ΔI(n) which can be obtained by a driving circuit according to the present invention under the same condition as in FIG. 3a.

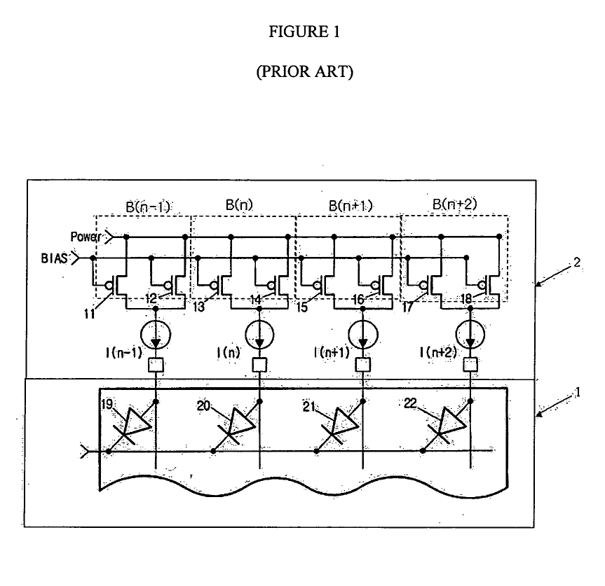

### DETAILED DESCRIPTION OF EMBODIMENTS

A driving circuit of an organic electroluminescence (EL) display according to one embodiment of the present invention will be described in detail with reference to the accompanying drawings. However, the present invention is not limited to the following embodiments. It will be apparent to one of ordinary skill in the art that the present invention is applicable to driving circuits for both passive and active matrix organic electroluminescence (EL) displays.

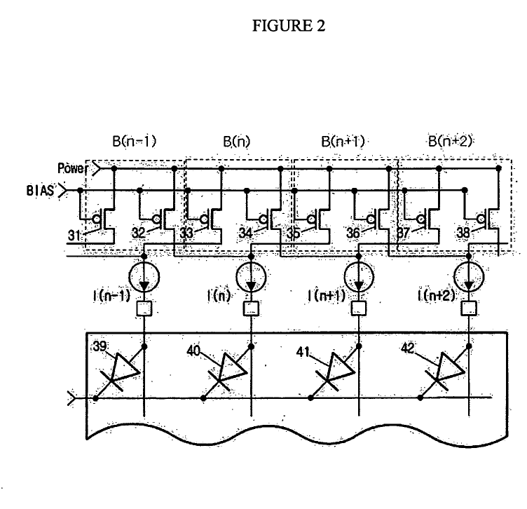

FIG. 2 is a simplified diagram of a driving circuit of an organic electroluminescence (EL) display according to one embodiment of the present invention. The organic electroluminescence (EL) display includes diodes 39, 40, 41, 42 assigned for each pixel, and the diodes 39, 40, 41, 42 operate with current flowing out of transistors 31, 32, 33, 34, 35, 36, 37, 38 assigned for each pixel.

In one embodiment, the transistors 31, 32, 33, 34, 35, 36, 37, 38 are p-channel metal-oxide semiconductor (PMOS) transistors used for complementary metal-oxide semiconductor (CMOS) transistors and function to operate a corresponding pixel. Source terminals of the transistors 31, 32, 33, 34, 35, 36, 37, 38 are coupled to a power source (Power) to generate driving current and their gate terminals are coupled to a bias (BIAS) to regulate the driving current. In other embodiments, the transistors 31, 32, 33, 34, 35, 36, 37, 38 may be bipolar junction transistors (BJTs).

Output current from the drain terminals of the transistors 31, 32, 33, 34, 35, 36, 37, 38 flow through the diodes 39, 40, 41, 42 assigned to each corresponding pixel. As shown in FIG. 2, transistor 32 of the transistor group B(n−1) and transistor 35 of the transistor group B(n+1) are connected to the n-th pixel to supply a pixel driving current for the n-th pixel. In other words, the pixel driving current I(n) flowing through the n-th pixel is not equal to the sum of current flowing out of the drain terminals of transistors 33, 34 of B(n) that are most adjacent to the n-th pixel, but is equal to the sum of IB(n−1) which is the current flowing out of the drain terminal of transistor 32 of the transistor group B(n−1) and IB(n+1) which is the current flowing out of the drain terminal of transistor 35 of the transistor group B(n+1). In one embodiment, these transistors 32, 35 providing current to the n-th pixel are the transistors second nearest to the n-th pixel other than the transistors 33, 34. Similarly, the driving current I(n+1) flowing through the (n+1)-th pixel is equal to the sum of IB(n) flowing out of the drain terminal of the transistor 34 of the transistor group B(n) and IB(n+2) flowing out of the drain terminal of the transistor 37 of the transistor group B(n+2).

The present invention has the benefit of reducing the variations in the pixel driving current of adjacent pixels, which will be apparent from Equation 3 illustrated below. Therefore, ΔI(n), which is the difference between the pixel driving current I(n) flowing through the n-th pixel and the pixel driving current I(n+1) flowing through the (n+1)-th pixel, is equal to the sum of (i) the value obtained by subtracting the current IB(n) flowing out of the drain terminal of transistor 34 of the transistor group B(n) from the current IB(n−1) flowing out of the drain terminal of transistor 32 of the transistor group B(n−1) and (ii) the value obtained by subtracting the current IB(n+2) flowing out of the drain terminal of transistor 37 of the transistor group B(n+2) from the current IB(n+1) flowing out of the drain terminal of transistor 35 of the transistor group B(n+1).

This follows from the following equation:

$$\begin{matrix}Δ I ( n - 1 ) = I ( n - 1 ) - I ( n ) \\ = IB ( n - 2 ) - IB ( n - 1 ) + IB ( n ) - IB ( n + 1 ) \\ = 0.5 \times \{ I ( n - 2 ) - I ( n - 1 ) \} + 0.5 \times \\ \{ I ( n ) - I ( n + 1 ) \} \\ = 0.5 \times Δ I ( n - 2 ) + 0.5 \times Δ I ( n ) , \\ Δ I ( n ) = I ( n ) - I ( n + 1 ) \\ = IB ( n - 1 ) - IB ( n ) + IB ( n + 1 ) - IB ( n + 2 ) \\ = 0.5 \times \{ I ( n - 1 ) - I ( n ) \} + 0.5 \times \\ \{ I ( n + 1 ) - I ( n + 2 ) \} \\ = 0.5 \times Δ I ( n - 1 ) + 0.5 \times Δ I ( n + 1 ) , \\ Δ I ( n + 1 ) = I ( n + 1 ) - I ( n + 2 ) \\ = IB ( n ) - IB ( n + 1 ) + IB ( n + 2 ) - IB ( n + 3 ) \\ 0.5 \times \{ I ( n ) - I ( n + 1 ) \} + 0.5 \times \{ I ( n + 2 ) - I ( n + 3 ) \} \\ 0.5 \times Δ I ( n ) + 0.5 \times Δ I ( n + 2 ) ,\end{matrix} \qquad [ Equation 3 ]$$

The above equations show that the difference between the pixel driving current flowing through the n-th and the (n+1)-th pixels is equal to a sum of (i) one half of the value obtained by subtracting the current I(n) flowing through the n-th pixel from the current I(n−1) flowing through the (n−1)-th pixel and (ii) one half of the value obtained by subtracting the current I(n+2) flowing through the (n+2)-th pixel from the current I(n+1) flowing through the (n+1)-th pixel. This means that the difference between the pixel driving current flowing through two adjacent pixels depends not only on current flowing out of the transistors geometrically most adjacent to each of the two adjacent pixels but also on the current flowing out of other transistors, so that the variation in differences between the pixel driving current is reduced.

Accordingly, the driving circuit of the organic electroluminescence (EL) display according to the present invention can reduce the variation in differences between the pixel driving current flowing through two adjacent pixels, thereby improving the display quality of an organic EL display.

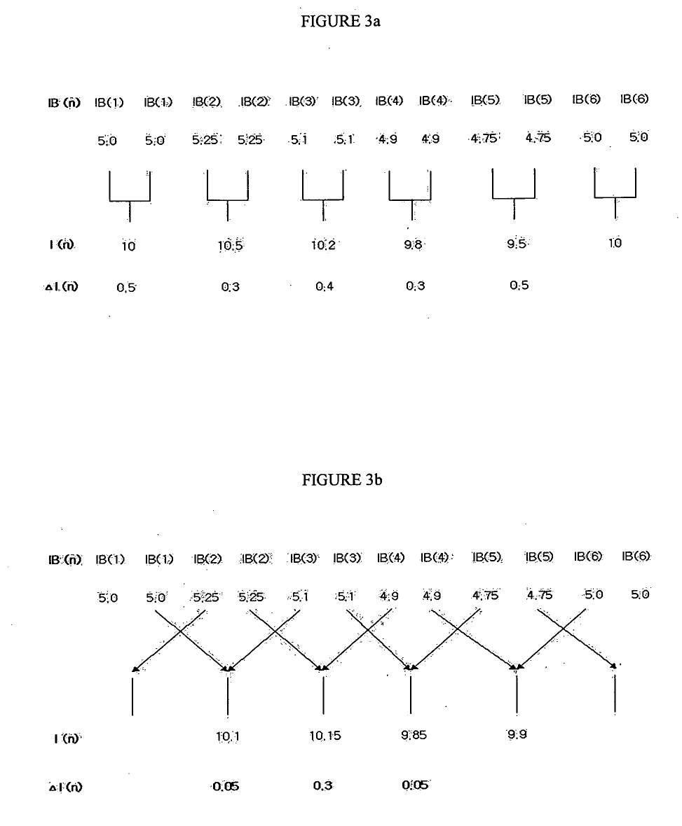

FIG. 3a illustrates ΔI(n) which is obtained by the conventional driving circuit. FIG. 3b illustrates ΔI(n) which can be obtained by the present invention under the same condition as in FIG. 3a. Both in FIG. 3a and FIG. 3b, current IB(n) flowing out of a transistor of transistor group B(n) have illustrative values as follows: IB(1)=5.0 μA, IB(2)=5.25 μA, IB(3)=5.1 μA, IB(4)=4.9 μA, IB(5)=4.75 μA, IB(6)=5.0 μA.

However, I(n) and ΔI(n) obtained by using the same values of IB(n) are different from each other in FIGS. 3a and 3b. That is, I(2), I(3), I(4) and I(5) in FIG. 3a are 10.5 μA, 10.2 μA, 9.8 μA and 9.5 μA respectively. However, I(2), I(3), I(4) and I(5) in FIG. 3b are 10.1 μA, 10.15 μA, 9.85 μA and 9.9 μA respectively. The difference in driving current flowing through adjacent pixels is reduced by uniquely arranging pixels and transistors providing the driving current to the pixels according to the present invention. For example, the difference between the driving current for pixel 2 and the driving current for pixel 3 in FIG. 3a is 0.3 μA, but the difference between the driving current for pixel 2 and the driving current for pixel 3 in FIG. 3b is 0.05 μA. Accordingly, the driver according to the present invention improves the display quality of organic EL display by reducing variations in differences between the driving current flowing through adjacent pixels.

Although the present invention has been described above with respect to several embodiments, various modifications can be made within the scope of the present invention. Accordingly, the disclosure of the present invention is intended to be illustrative, but not limiting, of the scope of the invention, which is set forth in the following claims.

1. A driver for an organic electroluminescence display, comprising:
a plurality of transistors for providing driving current to corresponding pixels of the organic electroluminescence display; and
circuitry coupling each of the plurality of transistors to the corresponding pixel to provide the driving current for the corresponding pixel from the transistors other than the transistors that are geometrically most adjacent to the corresponding pixel.

2. The driver of claim 1, wherein the current I(n) flowing through an n-th pixel of the organic electroluminescence display is equal to a sum of a current IB(n−1) provided by a first transistor belonging to a transistor group B(n−1) geometrically most adjacent to an (n−1)-th pixel of the organic electroluminescence display and a current IB(n+1) provided by a second transistor belonging to a transistor group B(n+1) geometrically most adjacent to an (n+1)-th pixel of the organic electroluminescence display, where n is a positive integer.

3. The driver of claim 2, wherein a difference ΔI(n) between the current I(n) and a current I(n+1) flowing through the (n+1)-th pixel is equal to a sum of one half of a value obtained by subtracting the current I(n) from a current I(n−1) flowing through an (n−1)-th pixel and one half of a value obtained by subtracting a current I(n+2) flowing through a (n+2)-th pixel from the current I(n+1).

4. The driver of claim 1, wherein the driving current for the corresponding pixel is provided by the transistors that are second nearest to the corresponding pixel.

5. The driver of claim 1, wherein the driving current for the corresponding pixel is provided by two transistors that are not geometrically most adjacent to the corresponding pixel.

6. The driver of claim 1, wherein the transistors are complementary metal-oxide semiconductor (CMOS) transistors.

7. The driver of claim 1, wherein the transistors are bipolar junction transistors (BJTs).

8. An organic electroluminescence display device comprising:
a plurality of organic light-emitting diodes arranged in rows and columns; and
a driver including a plurality of transistors for providing driving current to corresponding pixels of the organic light-emitting diodes, the driving current for the corresponding pixel being provided from the transistors other than the transistors that are geometrically most adjacent to the corresponding pixel.

9. The organic electroluminescence display device of claim 8, wherein the current I(n) flowing through an n-th pixel of the organic electroluminescence display device is equal to a sum of a current IB(n−1) provided by a first transistor belonging to a transistor group B(n−1) geometrically most adjacent to an (n−1)-th pixel of the organic electroluminescence display device and a current IB(n+1) provided by a second transistor belonging to a transistor group B(n+1) geometrically most adjacent to an (n+1)-th pixel of the organic electroluminescence display device, where n is a positive integer.

10. The organic electroluminescence display device of claim 9, wherein a difference ΔI(n) between the current I(n) and a current I(n+1) flowing through the (n+1)-th pixel is equal to a sum of one half of a value obtained by subtracting the current I(n) from a current I(n−1) flowing through an (n−1)-th pixel and one half of a value obtained by subtracting a current I(n+2) flowing through a (n+2)-th pixel from the current I(n+1).

11. The organic electroluminescence display device of claim 8, wherein the driving current for the corresponding pixel is provided by the transistors that are second nearest to the corresponding pixel.

12. The organic electroluminescence display device of claim 8, wherein the driving current for the corresponding pixel is provided by two transistors that are not geometrically most adjacent to the corresponding pixel.

13. The organic electroluminescence display device of claim 8, wherein the transistors are complementary metal-oxide semiconductor (CMOS) transistors.

14. The organic electroluminescence display device of claim 8, wherein the transistors are bipolar junction transistors (BJTs).
